(19) United States
(12) Patent Application Publication
(10) Pub. No.: US 2020/0076925 A1
(43) Pub. Date: Mar. 5, 2020

(54) Software-defined Interconnection Method and Apparatus for Heterogeneous Protocol Data

(71) Applicants: Tianjin Chip Sea Innovation Technology Co. Ltd., Tianjin (CN); CHINA NATIONAL DIGITAL SWITCHING SYSTEM ENGINEERING & TECH R&D CENTER, HENAN (CN)

(72) Inventors: Jiangxing WU, Henan (CN); Qinrang LIU, Henan (CN); Ping LV, Henan (CN); Jianliang SHEN, Henan (CN); Ke ZHU, Tianjin (CN); Ke SONG, Henan (CN); Dongpei LIU, Henan (CN); Ting CHEN, Henan (CN); Peijie LI, Henan (CN); Xin Wang, Henan (CN)

(21) Appl. No.: 16/402,968

(22) Filed: May 3, 2019

(30) Foreign Application Priority Data
Aug. 29, 2018 (CN) CN201811009771.1

(51) Int. Cl. H04L 29/06; H04L 12/46; H04L 12/741

(52) U.S. Cl. CPC H04L 69/08; H04L 12/4633; H04L 2212/00; H04L 69/18; H04L 45/745

(57) ABSTRACT

The present disclosure provides a software-defined interconnection method and apparatus for heterogeneous protocol data, including: determining ports respectively corresponding to multiple network node devices connected with a software-definable network switching device; configuring each of the ports corresponding to a respective network node device according to a protocol type corresponding to the network node device, to obtain the first configuration information, and configure a port rate of the port according to a transmission rate of data of the network node devices, to obtain the second configuration information; receiving a data packet sent by the connected network node device through each of the ports; determining whether protocol conversion needs to be performed according to the protocol type of the destination port of the data packet, wherein if needed, the data packet sent from the port is encapsulated into the protocol type of the destination port, and sent to the destination port.

### CROSS-REFERENCE TO RELATED APPLICATION

The present disclosure claims the priority to the Chinese patent application with the filing No. 2018110097711, filed on Aug. 29, 2018 with the Chinese Patent Office, entitled “Software-defined Interconnection Method and Apparatus for Heterogeneous Protocol Data”, the contents of which are incorporated herein by reference in their entirety.

### BACKGROUND ART

At present, infrastructures of information system such as data center, high performance computing, edge computing, and video surveillance usually demand interconnection for heterogeneous protocol data, for example, a rigid protocol bridging technology is widely adopted for protocol data such as Ethernet, Fibre Channel (FC), Peripheral Component Interconnect express (PCIe), and rapid input and output (RapidIO). In order to achieve data communication between different protocols, an interconnection system usually needs to comprise a plurality of protocol switching devices, for example, assume that the interconnection system comprises three heterogeneous protocols, i.e. protocol A, protocol B, and protocol C, then the interconnection system needs to comprise following parts: a switching device for protocol A, a switching device for protocol B, a switching device for protocol C, a bridging device for protocols A and B, a bridging device for protocols A and C, and a bridging device for protocols B and C, wherein the switching device for protocol A is configured as a switching device for interconnection and intercommunication among N1 (N1≥2) different devices (network node devices); the switching device for protocol C is configured as a switching device for interconnection and intercommunication among N3 (N3≥2) different devices (network node devices); the bridging device for protocols A and B is configured to perform protocol conversion between the protocol A and the protocol B; the bridging device for protocols A and C is configured to perform protocol conversion between the protocol A and the protocol C; the bridging device for protocols B and C is configured to perform protocol conversion between the protocol B and the protocol C. When data communication is performed among the three heterogeneous protocols, single protocol switches and bridging devices for protocol conversion are required.

### SUMMARY

In a first aspect, an embodiment of the present disclosure provides a software-defined interconnection method for heterogeneous protocol data, applicable to a network switching device, wherein the method comprises:

determining ports respectively corresponding to multiple network node devices connected with the network switching device;

configuring each of the ports corresponding to the respective network node device according to protocol type corresponding to the network node device, to obtain first configuration information, and configuring port rate of the port according to transmission rate of data of the respective network node device, to obtain second configuration information;

receiving a data packet sent by the connected network node device through each of the ports; and

determining whether protocol conversion needs to be performed according to a protocol type of a destination port of the data packet;

wherein if needed, the data packet sent from the port is encapsulated into the protocol type of the respective destination port, and sending the encapsulated data packet to the destination port.

In a second aspect, an embodiment of the present disclosure provides a software-defined interconnection apparatus for heterogeneous protocol data, comprising a port module group, a protocol parsing and conversion module group, and a protocol independent switching module, wherein the port module group comprises multiple port modules, the protocol parsing and conversion module group comprises multiple protocol parsing and conversion modules, and the port modules, the protocol parsing and conversion modules, and the protocol independent switching module are connected in sequence;

the port modules are configured to determine ports respectively corresponding to multiple network node devices connected with the network switching device, configure each of the ports corresponding to the respective network node device according to protocol type corresponding to the network node device to obtain first configuration information, and configure port rate of the port according to transmission rate of data of the respective network node device to obtain second configuration information;

the protocol parsing and conversion modules are configured to receive the data packet sent by the respective connected network node device through each of the ports, and determine whether protocol conversion needs to be performed according to a protocol type of destination port of the data packet, wherein if needed, the data packet sent from the ports is encapsulated into the protocol type of the destination port; and the protocol independent switching module is configured to send the data packet which is encapsulated into the protocol type of the destination port to the destination port.

In a third aspect, the present disclosure provides a network switching device, comprising a machine readable storage medium and a processing unit, wherein a machine-executable instruction is stored on the machine readable storage medium, when the machine executable instruction is executed by the processing unit, the network switching device is caused to realize the software-defined interconnection method for heterogeneous protocol data provided in the present disclosure.

Other features and advantages of the present disclosure will be illustrated in the following description, and partly become apparent from the description, or be understood by implementation of the present disclosure. The objects and other advantages of the present disclosure are realized and obtained by structures specifically indicated in the description, the claims, and the accompanying drawings.

In order to make the above objects, features, and advantages of the present disclosure more apparent and easily understandable, preferable examples are particularly illustrated in the following to make detailed description in conjunction with the accompanying drawings.

### BRIEF DESCRIPTION OF DRAWINGS

In order to more clearly illustrate technical solutions in embodiments of the present disclosure or in the prior art, accompanying drawings which are needed for description of the embodiments or the prior art will be introduced briefly below, and apparently, the accompanying drawings in the description below are merely for some embodiments of the present disclosure, and a person ordinarily skilled in the art still can obtain other accompanying drawings in light of these accompanying drawings, without using inventive effort.

FIG. 1 is a flow chart of a software-defined interconnection method for heterogeneous protocol data provided in Embodiment 1 of the present disclosure;

FIG. 2 is a schematic diagram of a software-defined interconnection apparatus for heterogeneous protocol data provided in Embodiment 2 of the present disclosure;

FIG. 3 is a schematic diagram of a networking (network formation) system provided in Embodiment 3 of the present disclosure;

FIG. 4a to FIG. 4c are schematic diagrams of multiple networking systems provided in Embodiment 4 of the present disclosure; and

FIG. 5a and FIG. 5b are schematic diagrams of hybrid protocol networking systems provided in Embodiment 5 of the present disclosure.

### REFERENCE SIGNS

10-network switching device; 20-configuration management module; 30-port module group; 31-port module; 40-protocol parsing and conversion module group; 41-protocol parsing and conversion module; 50-protocol independent switching module.

### DETAILED DESCRIPTION OF EMBODIMENTS

In order to make objects, technical solutions, and advantages of the embodiments of the present disclosure clearer, the technical solutions of the present disclosure will be described clearly and completely below in conjunction with accompanying drawings, apparently, some but not all embodiments of the present disclosure are described. All other embodiments obtained by a person ordinarily skilled in the art based on the embodiments of the present disclosure without any inventive efforts shall fall within the scope of protection of the present disclosure.

In some existing embodiments, when data interaction and interconnection is performed among heterogeneous protocols, since a switching device supports a fixed protocol type, in order to realize data interaction among different protocols, a specific bridging device should be employed for protocol format translation and semantic conversion, while the bridging device usually only can realize conversion between two specific protocols, then bridging among multiple heterogeneous protocols results in a great variety of devices, leading to complexity of network deployment. Therefore, the embodiments of the present disclosure provide an interconnection method for heterogeneous protocol data and an interconnection apparatus for heterogeneous protocol data, which can support data interconnection among multiple heterogeneous protocols simply by means of a software-defined network switching device, without any external bridging device needed, thus simplifying the network deployment, and facilitating the management.

In order to facilitate understanding the present embodiment, the embodiment of the present disclosure is introduced in detail below.

### Embodiment 1

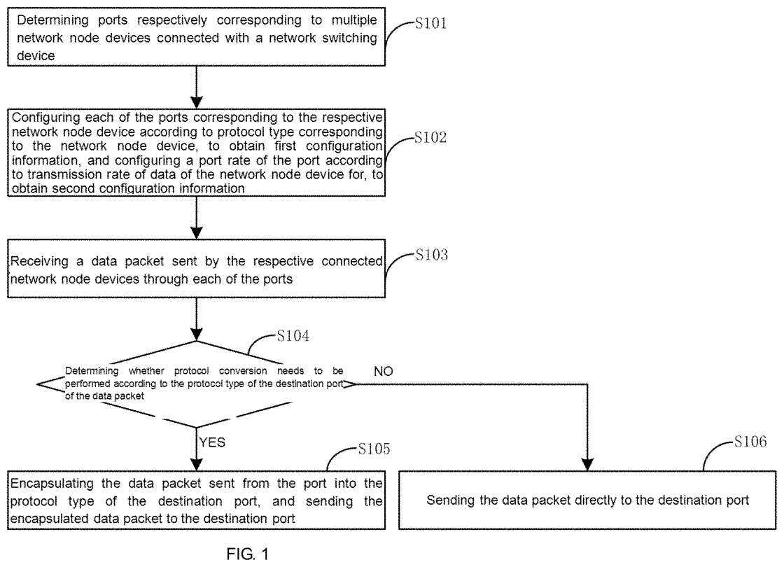

FIG. 1 is a flow chart of a software-defined interconnection method for heterogeneous protocol data provided in Embodiment 1 of the present disclosure.

Referring to FIG. 1, the software-defined interconnection method provided in the present embodiment is applicable to a network switching device, which method at least comprises following steps:

Step S101: determining ports respectively corresponding to multiple network node devices connected with the network switching device.

The ports described in the text may act as source ports, and also may act as destination ports.

Step S102: configuring each of the ports corresponding to the respective network node device according to a protocol type corresponding to the network node device, to obtain first configuration information, and configuring a port rate of the port according to transmission rate of data of the network node device, to obtain second configuration information.

Specifically, according to networking requirements (requirement for networking) and the protocol type of each network node device, by configuring the transmission rate of data of the network node device and protocol type and switching pattern of each port of the network node device, each port and the network node device connected therewith are enabled to have an identical protocol type, and the networking requirements of the connected network node device are satisfied.

The network switching device, according to working states of each connected network node device, realizes software definition of binding patterns and the transmission rates of data at various ports and so on, such that normal connection is established between the various ports and the network node devices connected therewith.

In one example, the network switching device obtains the first configuration information and the second configuration information in response to receipt of configuration operations on each port of the network switching device performed by an administrator via configuration software or another configuration device. In another example, the network switching device also may automatically perform data interaction with the network node devices connected with the various ports, to obtain communication feature information such as protocol types or transmission rates corresponding to the network node devices, and obtain the first configuration information and the second configuration information according to the obtained communication feature information.

Step S103: receiving a data packet sent by the respective connected network node device through each of the ports.

In the present embodiment, the network switching device may receive the data packet sent by the corresponding network node device according to the first configuration information and the second configuration information of each port obtained in step S102.

Step S104: determining whether protocol conversion needs to be performed according to the protocol types of the destination ports of the data packet, wherein if needed, step S105 is performed; if not needed, step S106 is performed.

Optionally, in Step S104, the network switching device can parse the data packet, and search, according to a destination address of the data packet, for a destination port needed for sending the data packet; determine a protocol type corresponding to the destination port according to the first configuration information of the destination port, and determine the protocol type corresponding to the source port according to the first configuration information of the source port for receiving the data packet; detect whether the protocol type corresponding to the source port is consistent with the protocol type corresponding to the destination port, wherein if not consistent, it is determined that protocol conversion needs to be performed; if consistent, it is determined that no protocol conversion needs to be performed.

Step S105: encapsulating the data packet sent from the port into the protocol type of the destination port, and sending the encapsulated data packet to the destination port.

Herein, after being encapsulated into the protocol type of the destination port, the data packet is sent to the destination port, and thus enters a destination device, to complete subsequent processing.

In the present embodiment, the network switching device can decapsulate the received data packet according to the first configuration information and the second configuration information of the source port, and re-encapsulate the data packet according to the first configuration information corresponding to the destination port, and then send the re-encapsulated data packet to a destination device through the destination port according to the second configuration information of the destination port.

Step S106: sending the data packet to the destination port directly.

Optionally, the software-defined interconnection method provided in the present embodiment may further comprise following steps:

Step S201: determining a switching scale and a switching pattern according to the number and types of the network node devices connected with the network switching device.

Optionally, the software-defined interconnection method provided in the present embodiment may further comprise following steps:

Step S301: determining a maximum connection number of the network node devices according to the number of ports of the network switching device.

Optionally, the network node devices may include storage devices, processing devices, and/or switching devices; the network switching device may include a software-defined single protocol switch or a software-defined hybrid protocol switch.

The software-defined interconnection method for heterogeneous protocol data provided in the embodiment of the present disclosure comprises: determining ports respectively corresponding to multiple network node devices connected with the network switching device; configuring each of the ports corresponding to the respective network node device according to the protocol type corresponding to the network node device, to obtain the first configuration information, and configure the port rate of the port according to the transmission rate of data of the network node device, to obtain the second configuration information; receiving the data packet sent by the respective connected network node device through each of the ports; determining whether protocol conversion needs to be performed according to the protocol type of the destination port of the data packet, wherein if needed, the data packet sent from the port is encapsulated into the protocol type of the destination port, and sent to the destination port, without any external bridging device needed. Data interconnection among multiple heterogeneous protocols can be supported simply by means of the software-defined network switching device, thus simplifying the network deployment, and facilitating the management.

### Embodiment 2

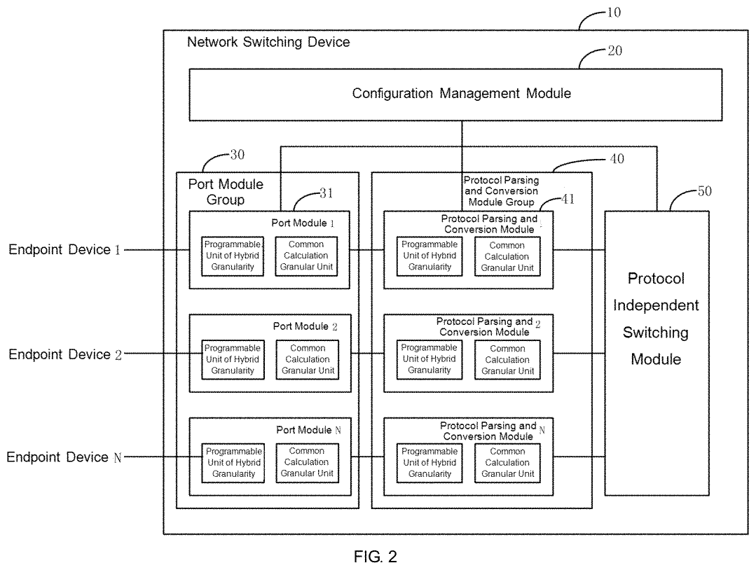

FIG. 2 is a schematic diagram of a software-defined interconnection apparatus for heterogeneous protocol data provided in Embodiment 2 of the present disclosure.

Referring to FIG. 2, the apparatus comprises a network switching device 10, wherein the network switching device 10 comprises a port module group 30, a protocol parsing and conversion module group 40, and a protocol independent switching module 50, wherein the port module group 30 comprises multiple port modules 31, the protocol parsing and conversion module group 40 comprises multiple protocol parsing and conversion modules 41, and the port modules 31, the protocol parsing and conversion modules 41, and the protocol independent switching module 50 are connected in sequence.

Herein, the network switching device 10 may be a software-defined interconnection apparatus, and in the present embodiment, a programmable configurability of the software-defined interconnection apparatus can be realized in a physical layer, initialization configuration is performed on the software-defined interconnection apparatus and reconfiguration is performed on an internal programmable unit of hybrid granularity via a reconfigurable configuration channel of the software-defined interconnection apparatus, to realize software definition of an interaction pattern, port binding patterns, transmission rates, protocol types of various ports and so on, such that the various ports of the software-defined interconnection apparatus and the network node devices interconnected therewith are of a consistent protocol type, so as to perform normal data communication.

The port modules 31 are configured to determine ports respectively corresponding to the multiple network node devices connected with the network switching device 10, configure each of the ports corresponding to the respective network node device according to a protocol type corresponding to the network node device, and configure a port rate of the port according to a transmission rate of data of the network node device. The port modules 31 can be used to realize Step S101 shown in FIG. 1.

The protocol parsing and conversion modules 41 are configured to receive a data packet sent by the respective connected network node device through each port, and determine whether protocol conversion needs to be performed according to a protocol type of the destination port of the data packet, wherein if needed, the data packet sent from the port is encapsulated into the protocol type of the destination port. The protocol parsing and conversion modules 41 can be used to realize Step S102 to Step S105 shown in FIG. 1.

The protocol independent switching module 50 is configured to send the data packet which is encapsulated into the protocol type of the destination port to the destination port, that is, the protocol independent switching module 50 is configured for data exchange among the various ports. Optionally, the protocol independent switching module 50 is further configured to directly send the data packet to the destination port in case that the protocol conversion needs to be performed. Optionally, the protocol parsing and conversion modules 41 receive the data packet sent by the corresponding network node device according to the first configuration information and the second configuration information of each of the ports, when receiving the data packet sent by the respective connected network node device through each of the ports.

Optionally, the protocol parsing and conversion modules 41, when determining whether the protocol conversion needs to be performed according to the protocol type of the destination port of the data packet, parse the data packet, search, according to a destination address of the data packet, for the destination port needed for sending the data packet, determine a protocol type corresponding to the destination port according to the first configuration information of the destination port, determine a protocol type corresponding to the source port according to the first configuration information of the source port for receiving the data packet, and detect whether the protocol type corresponding to the source port for receiving is consistent with the protocol type corresponding to the destination port, wherein if not consistent, it is determined that the protocol conversion needs to be performed; and if consistent, it is determined that no protocol conversion needs to be performed.

Optionally, the protocol parsing and conversion modules 41, when encapsulating the data packet sent from the port into the protocol type of the destination port, decapsulate the received data packet according to the first configuration information and the second configuration information of the source port for receiving, re-encapsulate the data packet according to the first configuration information corresponding to the destination port, and then send the re-encapsulated data packet to a destination device through the destination port according to the second configuration information of the destination port.

Optionally, the port modules 31 are further configured to determine a switching scale and a switching pattern according to the number and types of the network node devices connected with the network switching device.

Optionally, the port modules 31 are further configured to determine a maximum connection number of the network node devices according to the number of ports of the network switching device.

Optionally, a configuration management module 20 is further included, which is configured to send the first configuration information and the second configuration information to the port module group 30, the protocol parsing and conversion module group 40, and the protocol independent switching module 50. In the present embodiment, the configuration management module 20 may obtain the first configuration information and/or the second configuration information from a configuration device or configuration software.

The software-defined interconnection apparatus for heterogeneous protocol data provided in the embodiment of the present disclosure comprises: the port module group, the protocol parsing and conversion module group, and the protocol independent switching module, wherein the port module group comprises multiple port modules, the protocol parsing and conversion module group comprises multiple protocol parsing and conversion modules, the port modules, the protocol parsing and conversion modules, and the protocol independent switching module are connected in sequence; the port modules are configured to determine the ports respectively corresponding to the multiple network node devices connected with the network switching device, configure each of the ports corresponding to the respective network node device according to the protocol type corresponding to the network node device, to obtain the first configuration information, and configure the port rate of the port according to the transmission rates of data of the network node device, to obtain the second configuration information; the protocol parsing and conversion modules are configured to receive the data packet sent by the respective connected network node device through each port, and determine whether the protocol conversion needs to be performed according to the protocol type of the destination port of the data packet, wherein if needed, the data packet sent from the port is encapsulated into the protocol type of the destination port; the protocol independent switching module is configured to send the data packet which is encapsulated into the protocol type of the destination port to the destination ports. Data interconnection among multiple heterogeneous protocols can be supported simply by means of the software-defined network switching device, thus simplifying the network deployment, and facilitating the management.

### Embodiment 3

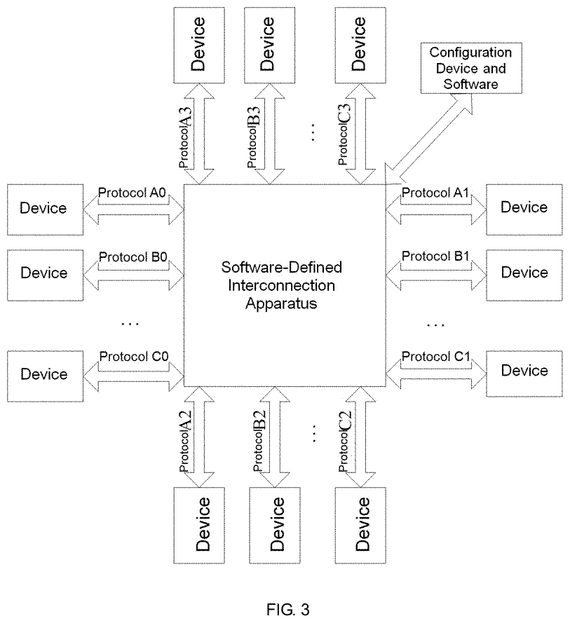

FIG. 3 is a schematic diagram of a networking system provided in Embodiment 3 of the present disclosure.

Referring to FIG. 3, protocol Ax, Bx, and Cx connected with a software-defined interconnection apparatus may be the same or different types, for example, protocols A1, B1, and C3 are all of type PCIe, other protocols are all of type FC, or A1 is of type FC, and the others are of type RapidIO, or the protocols are all of type FC, PCIe or RapidIO. It is not limited to the above protocols herein, but other protocols also may be included. In FIG. 3, devices are network node devices.

The network node devices may include storage devices, processing devices, and/or switching devices; the network switching device is the software-defined interconnection apparatus.

A configuration device is configured as a management platform managing the software-defined interconnection apparatus, in which an initialization program, a configuration program etc. of the software-defined interconnection apparatus are built internally.

### Embodiment 4

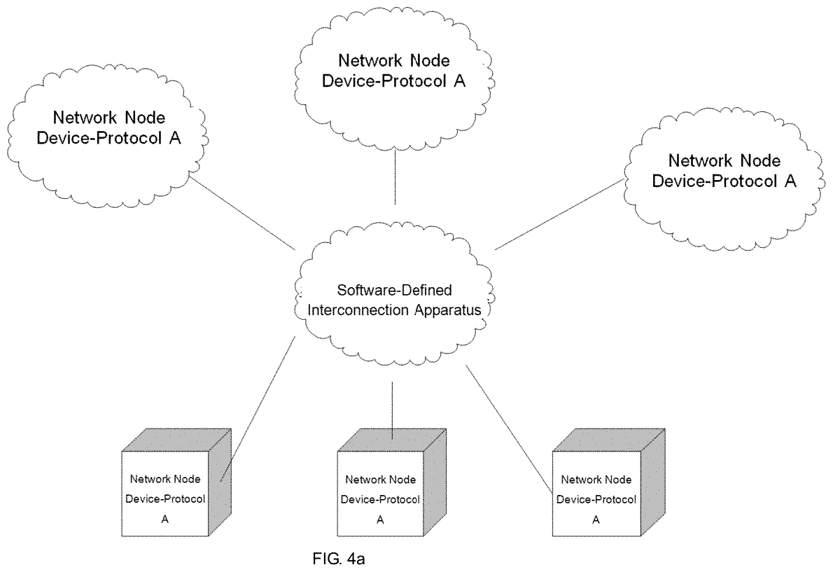

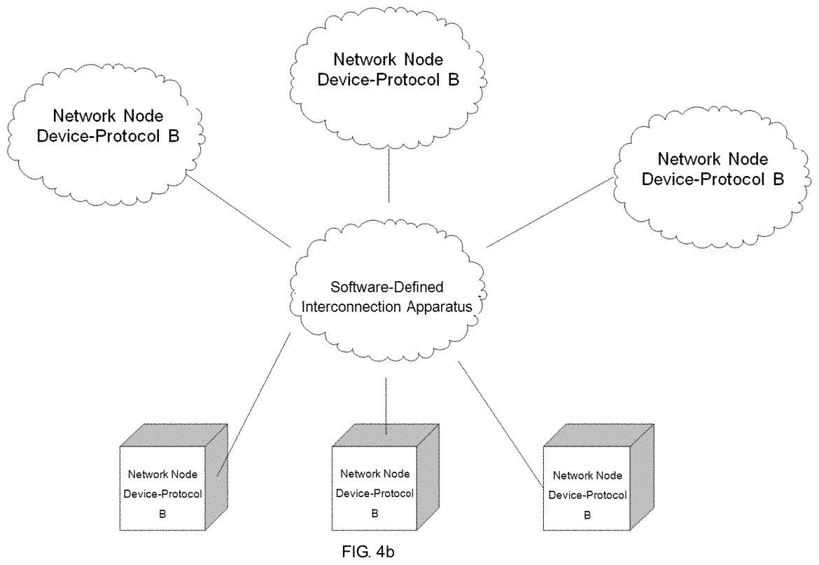

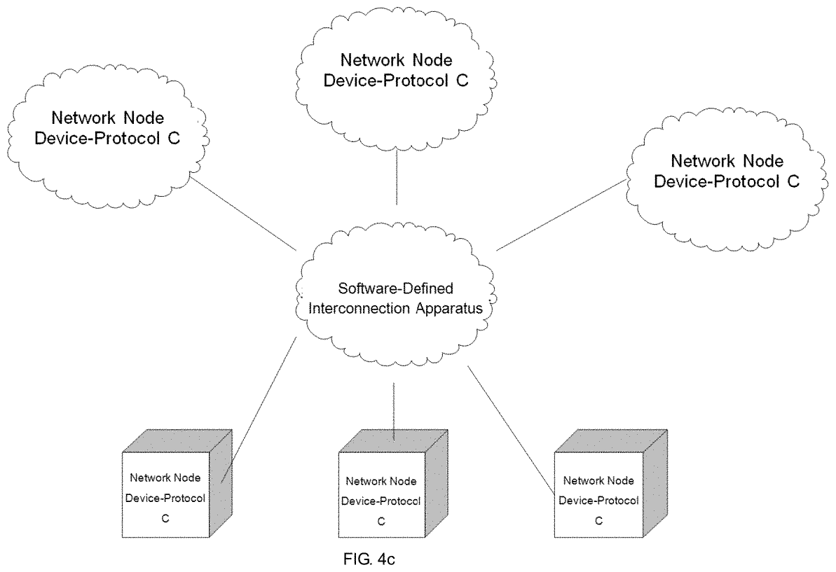

FIG. 4a to FIG. 4c are schematic diagrams of multiple networking systems provided in Embodiment 4 of the present disclosure.

Referring to FIG. 4a to FIG. 4c, a software-defined interconnection apparatus may be a single protocol interconnection device, and various network node devices connected therewith are of an identical protocol type, realizing independent networking of any protocol, wherein the number of the network node devices depends upon the number of ports of the software-defined interconnection apparatus. In FIG. 4a, the software-defined interconnection apparatus is connected with multiple network node devices, and all of them are of the protocol type A.

In FIG. 4b, the software-defined interconnection apparatus is connected with multiple network node devices, and all of them are of the protocol type B.

In FIG. 4c, the software-defined interconnection apparatus is connected with multiple network node devices, and all of them are of the protocol type C.

### Embodiment 5

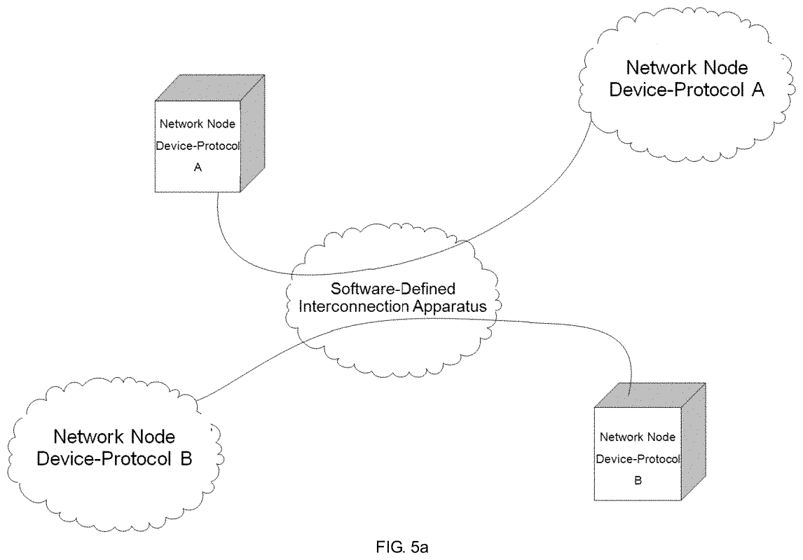

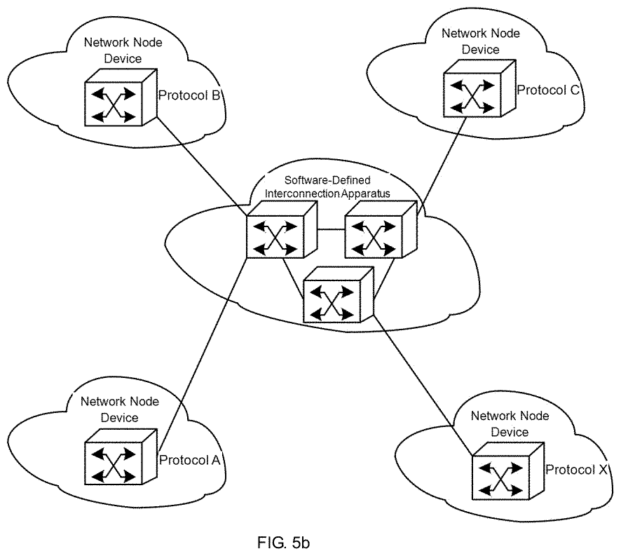

FIG. 5a and FIG. 5b are diagrams of hybrid protocol networking systems provided in Embodiment 5 of the present disclosure.

Referring to FIG. 5a and FIG. 5b, the hybrid protocol networking systems include networking without protocol conversion and networking with protocol conversion. FIG. 5a shows the networking without protocol conversion, wherein a software-defined interconnection apparatus may be connected with network node devices of N (N≥2) protocol types, to realize independent communication of the network node devices of the N (N≥2) different protocol types in a single software-defined interconnection apparatus, wherein one software-defined interconnection apparatus is equivalent to N fixed protocol switching devices.

FIG. 5b shows the networking with protocol conversion, wherein N (N≥2) network node devices are not of an identical protocol type, and in order to realize data exchange among devices of heterogeneous protocol types, protocol conversion needs to be realized between each two of N heterogeneous protocols in the software-defined interconnection apparatus.

For example, data exchange among N (N≥2, N=ΣNi) devices with four different protocols needs to be supported in a certain system, wherein devices with the protocol PCIe are in the number of N1, devices with the protocol RapidlO are in the number of N2, devices with the protocol FC are in the number of N3, and devices with the protocol Ethernet are in the number of N4.

With the presence of protocol conversion, first each port is software-defined, N ports are configured respectively according to the protocol types of the devices connected with the ports, and the software-defined interconnection apparatus supports four heterogeneous protocols in total; a rate of each channel is configured according to requirements of the respective connected device, and may be configured at typical frequencies supported by the four protocols, including 1.25 Gbps, 2.125 Gbps, 3.125 Gbps, 4.25 Gbps, 5 Gbps, 6.25 Gbps, 8.5 Gbps, 10.3125 Gbps, 12.5 Gbps etc., a channel binding pattern of each port is defined in synchronization, and the channel binding patterns required by multiple protocols such as 1×\2×\4×\8×\16× are supported; interconnection and intercommunication among the four protocols is supported in the software-defined interconnection apparatus (that is, 12 modes of protocol conversion are supported); the protocol conversion mode of each channel is defined according to requirements thereof; the switching scale is defined within the interconnection apparatus according to the number of ports and meanwhile the switching pattern is defined, so as to meet requirements of data transmission among the various ports; after the protocol conversion is completed, the data enters respective ports via the protocol independent switching module, to arrive at designated devices, realizing data transmission.

In absence of protocol conversion, the software-defined interconnection apparatus is regarded as a switch realizing four independent protocols, and no data exchange needs to be performed among devices of different protocol types. A specific process thereof is as follows: in the software-defined interconnection apparatus, first each port is software-defined, N ports are configured respectively according to protocol types of the devices connected with the ports, and the interconnection apparatus supports four heterogeneous protocols in total; a rate of each channel is configured according to requirements of the respective connected device, and may be configured at typical frequencies supported by the four protocols, including 1.25 Gbps, 2.125 Gbps, 3.125 Gbps, 4.25 Gbps, 5 Gbps, 6.25 Gbps, 8.5 Gbps, 10.3125 Gbps, 12.5 Gbps etc., a channel binding pattern of each port is defined in synchronization, and the channel binding patterns required by multiple protocols such as 1×\2×\4×\8×\16× are supported. After it is determined that no protocol conversion needs to be performed, the data can directly enter the protocol independent switching module, to arrive at a destination device, realizing exchange of data of a single protocol.

An embodiment of the present disclosure further provides a network switching device, comprising a machine readable storage medium, a processing unit, and a machine-executable instruction stored on the machine readable storage medium and runnable on a processor, wherein when the processing unit executes the machine-executable instruction, the network switching device is caused to realize the steps of the software-defined interconnection method for heterogeneous protocol data provided in the above embodiment.

An embodiment of the present disclosure further provides a computer readable storage medium on which a machine-executable instruction is stored, and when the machine-executable instruction is operated by a processor, the steps of the software-defined interconnection method for heterogeneous protocol data in the above embodiment are executed.

A computer program product provided in an embodiment of the present disclosure comprises a computer readable storage medium on which a program code is stored, and instructions comprised in the program code may be used to execute the method described in the method embodiment in the preceding. Reference may be made to the method embodiment for specific implementations, which will not be repeated redundantly herein.

A person skilled in the art could clearly know that for the sake of descriptive convenience and conciseness, reference can be made to corresponding processes in the method embodiment in the preceding for specific operation processes of the system and apparatus described above, and they will not be repeated redundantly herein.

In addition, in the description of the embodiments of the present disclosure, unless otherwise specified and defined explicitly, terms “mount”, “join”, and “connect” should be construed in a broad sense, for example, it may be fixed connection, detachable connection, or integral connection; it may be mechanical connection, and also may be electrical connection; it may be direct connection, indirect connection via an intermediate medium, or inner communication between two elements. For a person ordinarily skilled in the art, specific meanings of the above-mentioned terms in the present disclosure can be understood according to specific circumstances.

If the function is realized in a form of software functional unit and is sold or used as an individual product, it may be stored on one computer readable storage medium. Based on such understanding, the technical solutions in essence or parts making contribution to the prior art or parts of the technical solutions in the present disclosure can be jointly embodied in form of a software product and hardware product, and this computer software product is stored in a storage medium, comprising several instructions and configuration information for making the software-defined interconnection apparatus execute all or part of the steps of the methods of various embodiments of the present disclosure. The aforementioned storage medium includes various media on which program codes can be stored, such as U disk, mobile hard disk, Read-Only Memory (ROM), Random Access Memory (RAM), diskette and compact disk.

In the description of the present disclosure, it should be indicated that orientational or positional relations indicated by terms “center”, “upper”, “lower”, “left”, “right”, “vertical”, “horizontal”, “inner”, “outer” and so on are based on orientational or positional relations as shown in the accompanying drawings, merely for facilitating the description of the present disclosure and simplifying the description, rather than indicating or implying that related devices or elements have to be in the specific orientation or configured and operated in a specific orientation, therefore, they should not be construed as limiting the present disclosure. Besides, terms “first”, “second”, and “third” are merely for descriptive purpose, but should not be construed as indicating or implying relative importance.

Finally, it should be indicated that the embodiments above are merely for specific embodiments of the present disclosure, for illustrating the technical solutions of the present disclosure, rather than limiting the present disclosure. The scope of protection of the present disclosure is limited thereto. While the detailed description is made to the present disclosure with reference to the aforementioned embodiments, those ordinarily skilled in the art should understand that the technical solutions recited in the aforementioned embodiments still can be modified or readily changed, or equivalent substitutions can be made to some of the technical features therein; these modifications, changes, or substitutions do not make the corresponding technical solutions essentially depart from the spirit and scope of the technical solutions of the embodiments of the present disclosure, and all should be covered within the scope of protection of the present disclosure. Therefore, the scope of protection of the present disclosure should be based on the scope of protection of the claims.

### INDUSTRIAL APPLICABILITY

The embodiments of the present disclosure provide the software-defined interconnection method for heterogeneous protocol data and the software-defined interconnection apparatus for heterogeneous protocol data. The software-defined interconnection method for heterogeneous protocol data comprises: determining ports respectively corresponding to multiple network node devices connected with the network switching device; configuring each of the ports corresponding to the respective network node device according to the protocol type corresponding to the network node device, to obtain the first configuration information, and configure port rate of the port according to the transmission rate of data of the network node device, to obtain the second configuration information; receiving the data packet sent by the respective connected network node device through each of the ports; determining whether protocol conversion needs to be performed according to the protocol type of the destination port of the data packet, wherein if needed, the data packet sent from the port is encapsulated into the protocol type of the destination port, and sent to the destination port. Without any external bridging device needed, data interconnection among multiple heterogeneous protocols can be supported simply by means of network nodes, thus simplifying the network deployment, and facilitating the management.

What is claimed is:

1. A software-defined interconnection method for heterogeneous protocol data, applicable to a network switching device, comprising steps of:
determining ports respectively corresponding to multiple network node devices connected with the network switching device;
configuring each of the ports corresponding to a respective network node device according to a protocol type corresponding to the network node device, to obtain first configuration information, and configuring a port rate of the port according to a transmission rate of data of the network node device, to obtain second configuration information;
receiving through each of the ports a data packet sent by a respective connected network node device; and
determining whether protocol conversion needs to be performed according to a protocol type of a destination port of the data packet,
wherein if the protocol conversion needs to be performed, the data packet sent from the port is encapsulated into the protocol type of the destination port, and sent to the destination port.

2. The software-defined interconnection method for heterogeneous protocol data according to claim 1, wherein the step of determining whether protocol conversion needs to be performed according to a protocol type of a destination port of the data packet comprises:
directly sending, if no protocol conversion needs to be performed, the data packet to the destination port.

3. The software-defined interconnection method for heterogeneous protocol data according to claim 1, wherein the step of receiving through each of the ports a data packet sent by a respective connected network node device comprises:
receiving the data packet sent by corresponding network node device according to the first configuration information and the second configuration information of each of the ports.

4. The software-defined interconnection method for heterogeneous protocol data according to claim 1, wherein the step of determining whether protocol conversion needs to be performed according to a protocol type of a destination port of the data packet comprises:
parsing the data packet, and searching, according to a destination address of the data packet, for a destination port needed for sending the data packet;
determining a protocol type corresponding to the destination port according to the first configuration information of the destination port, and determining a protocol type corresponding to a source port according to the first configuration information of the source port which receives the data packet; and
detecting whether the protocol type corresponding to the source port is consistent with the protocol type corresponding to the destination port,
wherein if the protocol type corresponding to the source port is not consistent with the protocol type corresponding to the destination port, it is determined that the protocol conversion needs to be performed; and
if the protocol type corresponding to the source port is consistent with the protocol type corresponding to the destination port, it is determined that no protocol conversion needs to be performed.

5. The software-defined interconnection method for heterogeneous protocol data according to claim 4, wherein the step that the data packet sent from the port is encapsulated into the protocol type of the destination port and sent to the destination port comprises:
decapsulating the received data packet according to the first configuration information and the second configuration information of the source port; and
re-encapsulating the data packet according to the first configuration information corresponding to the destination port, and then sending the re-encapsulated data packet to a destination device through the destination port according to the second configuration information of the destination port.

6. The software-defined interconnection method for heterogeneous protocol data according to claim 1, further comprising steps of:
determining a switching scale and a switching pattern according to a number and types of the network node devices connected with the network switching device.

7. The software-defined interconnection method for heterogeneous protocol data according to claim 1, further comprising steps of:
determining a maximum connection number of the network node devices according to a number of the ports of the network switching device.

8. The software-defined interconnection method for heterogeneous protocol data according to claim 1, wherein the network node devices comprise storage devices, processing devices, and/or switching devices; and the network switching device is as a software-defined single protocol switch or a software-defined hybrid protocol switch.

9. A software-defined interconnection apparatus for heterogeneous protocol data, comprising a port module group, a protocol parsing and conversion module group, and a protocol independent switching module,
wherein the port module group comprises multiple port modules, the protocol parsing and conversion module group comprises multiple protocol parsing and conversion modules, and the port modules, the protocol parsing and conversion modules and the protocol independent switching module are connected in sequence;
the port modules are configured to
determine ports respectively corresponding to multiple network node devices connected with a network switching device,
configure each of the ports corresponding to a respective network node device according to a protocol type corresponding to the network node device to obtain first configuration information, and
configure a port rate of the port according to a transmission rate of data of the network node device to obtain second configuration information;
the protocol parsing and conversion modules are configured to receive through each of the ports a data packet sent by the respective connected network node device,
determine whether protocol conversion needs to be performed according to a protocol type of a destination port of the data packet, and
encapsulate, if the protocol conversion needs to be performed, the data packet sent from the port into the protocol type of the destination port; and
the protocol independent switching module is configured to send to the destination port the data packet encapsulated into the protocol type of the destination port.

10. The software-defined interconnection apparatus for heterogeneous protocol data according to claim 9, wherein the protocol independent switching module is further configured to directly send the data packet to the destination port in case that the protocol conversion needs to be performed.

11. The software-defined interconnection apparatus for heterogeneous protocol data according to claim 9, wherein each of the protocol parsing and conversion modules is configured to receive the data packet sent by corresponding network node device according to the first configuration information and the second configuration information of each of the ports when receiving through each of the ports the data packet sent by the respective connected network node device.

12. The software-defined interconnection apparatus for heterogeneous protocol data according to claim 9, wherein each of the protocol parsing and conversion modules is configured to, when determining whether protocol conversion needs to be performed according to a protocol type of a destination port of the data packet,
parse the data packet,
search, according to a destination address of the data packet, for the destination port needed for sending the data packet,
determine a protocol type corresponding to the destination port according to the first configuration information of the destination port,
determine a protocol type corresponding to a source port according to the first configuration information of the source port which receives the data packet,
detect whether the protocol type corresponding to the source port is consistent with the protocol type corresponding to the destination port,
determine, if the protocol type corresponding to the source port is not consistent with the protocol type corresponding to the destination port, that the protocol conversion needs to be performed, and
determine, if the protocol type corresponding to the source port is consistent with the protocol type corresponding to the destination port, that no protocol conversion needs to be performed.

13. The software-defined interconnection apparatus for heterogeneous protocol data according to claim 12, wherein each of the protocol parsing and conversion modules is configured to, when encapsulating the data packet sent from the port into the protocol type of the destination port,
decapsulate the received data packet according to the first configuration information and the second configuration information of the source port; and
re-encapsulate the data packet according to the first configuration information corresponding to the destination port, and then send the re-encapsulated data packet to a destination device through the destination port according to the second configuration information of the destination port.

14. The software-defined interconnection apparatus for heterogeneous protocol data according to claim 9, wherein each of the port modules is further configured to determine a switching scale and a switching pattern according to a number and types of the network node devices connected with the network switching device.

15. The software-defined interconnection apparatus for heterogeneous protocol data according to claim 9, wherein each of the port modules is further configured to determine a maximum connection number of the network node devices according to a number of the ports of the network switching device.

16. The software-defined interconnection apparatus for heterogeneous protocol data according to claim 9, further comprising a configuration management module configured to send the first configuration information and the second configuration information to the port module group, the protocol parsing and conversion module group, and the protocol independent switching module.

17. A network switching device, comprising a machine readable storage medium and a processing unit, wherein a machine-executable instruction is stored on the machine readable storage medium, and when the machine-executable instruction is executed by the processing unit, the network switching device is caused to realize the method according to claim 1.

18. The network switching device according to claim 17, wherein the step of determining whether protocol conversion needs to be performed according to a protocol type of a destination port of the data packet comprises:
directly sending, if no protocol conversion needs to be performed, the data packet to the destination port.

19. The network switching device according to claim 17, wherein the step of receiving through each of the ports a data packet sent by a respective connected network node device comprises:
receiving the data packet sent by corresponding network node device according to the first configuration information and the second configuration information of each of the ports.

20. The network switching device according to claim 17, wherein the step that the data packet sent from the port is encapsulated into the protocol type of the destination port and sent to the destination port comprises:
decapsulating the received data packet according to the first configuration information and the second configuration information of the source port; and
re-encapsulating the data packet according to the first configuration information corresponding to the destination port, and then sending the re-encapsulated data packet to a destination device through the destination port according to the second configuration information of the destination port.
